(19) United States
(12) Patent Application Publication
(10) Pub. No.: US 2015/0273783 A1
(43) Pub. Date: Oct. 1, 2015

(54) Heat-shrinkable plastic bag package with integrated handle

(71) Applicants: Timothy Copp, Danbury, CT (US); G. Taylor Richey, Hopewell Jct, NY (US)

(72) Inventors: Timothy Copp, Danbury, CT (US); G. Taylor Richey, Hopewell Jct, NY (US)

(21) Appl. No.: 13/573,362

(22) Filed: Sep. 12, 2012

(51) Int. Cl. B31B 41/00

(52) U.S. Cl. CPC B31B 41/00

(57) ABSTRACT

Methods are disclosed for producing finished packages. A bag is made from heat-shrinkable material and has a container portion with an open end and a closed end, and an integrated handle portion. An object to be packaged is placed through the open end of the bag into the container portion, and the open end is sealed. Heat is then applied to the bag while insulating the integrated handle portion so that a finished package is obtained with an unshrunken integrated handle portion and a container portion that is shrunk around the object.

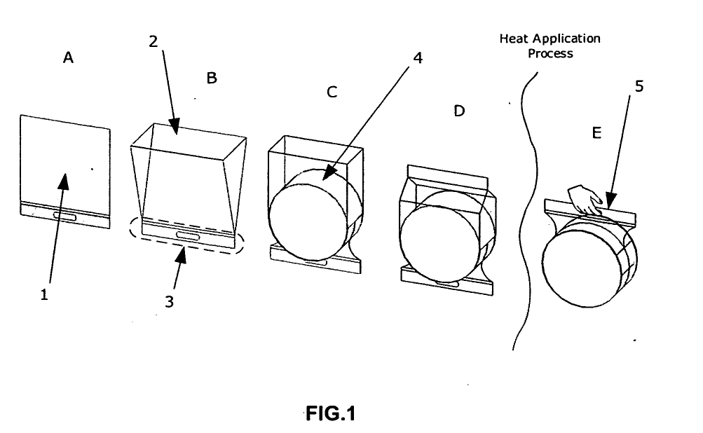

### BACKGROUND OF THE INVENTION

1. Field of the Invention

This invention relates to the manufacture of Heat-Shrinkable Plastic Bags partitioned into two sections, namely a first section comprising the plastic bag and (2) a second section comprising a handle and wherein the handle is isolated from the plastic bag which uses applied heat to form the bag section.

2. Related Art

This invention relates to U.S. application Ser. No. 13/506574, filed Apr. 30, 2012 and entitled: Proflex Shrink Bag with Handle and assigned to REELEX Packaging Solutions, Inc., the same entity as the present invention. The present invention broadens the scope of the first filed patent application.

### SUMMARY OF THE INVENTION

A method for packaging an object so that a single heat-shrinkable plastic bag is partitioned into a container section that has been shrunk around the product and a separate section that has been isolated from the application of heat and is thus able to retain its original form. The package design allows for a single material to take on two distinct characteristics simultaneously; (1) a heat-shrunk container designed to tightly contain the product being packaged; and (2) a non-shrunk area of plastic film that is allowed to remain undisturbed to form a handle for the package.

The non-shrunk area of the film typically is equipped with a oval-shaped cut out designed to be used as a hand-hold. This handle cut out is isolated from a heat source, and would shrivel upon itself and thus not be allowed to function as a handhold.

### BRIEF DESCRIPTION OF THE DRAWING

The objects, features and advantages of the invention are readily apparent from the following description of a referred embodiment of the best mode of carrying out the invention when taken in conjunction with the following sole FIGURE, wherein:

The steps of the inventive method for producing a heat-shrinkable bag package with an integrated handle is illustrated in the FIGURE.

A tube or bag made from heat-shrinkable material (typically plastic) is shown at A in the sole FIGURE. One end of this bag is pre-sealed to form a container with an open end (section B). The object to be packaged is inserted into the bag or container portion of the material (section C), and the open end of the container is sealed (section D). Heat is the applied to the entire package except for a portion of the material desired to be left undisturbed. The container portion of the package thus shrinks around the object, while the rest of the material is left in its natural state (section E). The finished package consists of a container portion shrunk around an object, and a non-shrunk portion that has been left unmolested.

The inventive package utilizes at section (A) a heat-shrinkable plastic film tube (1), which has been folded or sealed on one end and is open on the other end to form a container (2) (section B). Adjacent and connected to the sealed end is an area of the same film that has been designated to serve a specific purpose, such as a hand-hold 3 in section B that must remain in its original unmolested state to function properly as will become more apparent in the following description.

The container portion 2 of the film is intended to be shrunk by means of heat application to shrink and thus tightly surround an object (4) (section C) placed inside the bag 2. For the adjacent hand-hold area of the film to remain undisturbed, the entire area is insulated from the heat application and allowing it to remain not shrunken and in its original state (section D).

The package produced in accordance with the present invention can be used in any instance in which an object is to be packaged using heat-shrinkable film, and where a designated area of the film must be kept isolated from heat to serve another purpose, such as a handle for the object.

1. A method for producing a package including a heat-shrinkable plastic bag with an integrated handle, comprising the steps of:
pre-sealing a bag made from heat-shrinkable material to form a container portion with an open end, said bag having an integrated handle portion;
placing an object to be packaged into the container portion of the heat-shrinkable material;
sealing the open end of the container; and
applying heat to said container portion and not to said integrated handle portion of the heat-shrinkable material, thereby shrinking the container portion of the package with said heat-shrinkable material of said integral handle remaining undisturbed in its original form; wherein
the package as finished consists of said container portion shrunk around the object and a non-shrunk undisturbed portion that forms a handle for the finished package.

2. A method for producing a finished package, comprising:
obtaining a bag made from heat-shrinkable material and having a container portion with an open end and a closed end, and an integrated handle portion made from said heat-shrinkable material;
placing an object to be packaged through the open end into the container portion of the heat-shrinkable material;
sealing the open end of the container;
insulating said integrated handle portion;
applying heat to said bag of heat-shrinkable material while said integrated handle portion is insulated to form a finished package with the container portion of the package shrunk around the object and an unshrunken integrated handle portion.

3. A method according to claim 2,
said integrated handle portion extends adjacent said closed end of said bag made from heat-shrinkable material.

4. A method according to claim 2, wherein:
said bag comprises a plastic film tube.

5. A method according to claim 2, wherein:
said bag is rectangular having a first width at said open end and said handle, and
said finished package has said unshrunken integrated handle portion having said first width and a container portion shrunken around the object and having an irregular width including a portion with a width smaller than said first width.

6. A method according to claim 2, wherein:
said integrated handle portion defines a hand-hold opening.
